(19) United States
(12) Patent Application Publication
(10) Pub. No.: US 2026/0167049 A1
(43) Pub. Date: Jun. 18, 2026

(54) APPARATUS, SYSTEM AND METHOD FOR VEHICLE-TO-VEHICLE CHARGING

(71) Applicants: HYUNDAI MOTOR COMPANY, SEOUL (KR); KIA CORPORATION, SEOUL (KR); Myongji University Industry and Academia Cooperation Foundation, Yongin-si (KR)

(72) Inventors: Jae Hyuk Choi, Hwaseong-si (KR); Su Won Park, Seoul (KR); Min Ho Shin, Hwaseong-si (KR); Kyung Chan Kim, Seoul (KR)

(73) Assignees: HYUNDAI MOTOR COMPANY, SEOUL (KR); KIA CORPORATION, SEOUL (KR); Myongji University Industry and Academia Cooperation Foundation, Yongin-si (KR)

(21) Appl. No.: 19/225,708

(22) Filed: Jun. 2, 2025

(30) Foreign Application Priority Data
Dec. 17, 2024 (KR) 10-2024-0188527

(51) Int. Cl. B60L 53/68; B60L 53/57; B60L 53/65; B60L 53/66

(52) U.S. Cl. CPC B60L 53/68; B60L 53/57; B60L 53/65; B60L 53/66

(57) ABSTRACT

An apparatus for V2V charging based on OCPP is provided. The apparatus includes a supply equipment communication controller (SECC) based on ISO 15118, mounted on a vehicular Charging Station (VCS) for supplying energy for V2V charging and communicating with an electric vehicle for vehicle-to-vehicle (V2V) charging. The apparatus also includes an OCPP client (OCPP Cli) for communicating with the supply equipment communication controller (SECC), operating as an open charge point protocol (OCPP) client, and communicating with an OCPP server of a charging station management system (CSMS) for V2V charging management. The OCPP client executes an OCPP-based use case, reports a current status of the vehicular Charging Station (VCS) for V2V charging to the charging station management system (CSMS), and processes a response from the charging station management system (CSMS).

### CROSS-REFERENCE TO RELATED APPLICATION(S)

This application claims benefit of priority to Korean Patent Application No. 10-2024-0188527 filed on Dec. 17, 2024 in the Korean Intellectual Property Office, the disclosure of which is incorporated herein by reference in its entirety.

### TECHNICAL FIELD

The present disclosure relates to an apparatus, a system, and a method for vehicle-to-vehicle (V2V) charging.

### BACKGROUND

Generally, when an electric vehicle is equipped with a plug and charge (PnC) device for vehicle-to-vehicle (V2V) charging, the electric vehicle may be charged by electric vehicle charging.

An electric vehicle equipped with a general PnC device may only have the PnC device and may not have a payment function, such that only a free charging service may be provided. Accordingly, a paid charging service may not be provided.

Also, a general V2V charging system may not have a use case for open charge point protocol (OCPP)-based V2V charging, and may thus not support a function for (e.g., continuously) monitoring a current status of charging service vehicle. Accordingly, the general V2V charging system may not provide optimal dispatching service for V2V charging.

Also, a general V2V charging system also may not support (e.g., necessary) communication for V2V charging between a Vehicular Charging Station (VCS) supporting a V2V charging service and an electric vehicle receiving the charging and a charging station management system (CSMS).

### SUMMARY

An aspect of the present disclosure is to provide an apparatus, a system and a method for vehicle-to-vehicle charging which may provide a new use case based on open charge point protocol (OCPP) to provide (e.g., enable) communication and status monitoring between a vehicular Charging Station (VCS) and a charging station management system (CSM) to support payable vehicle-to-vehicle (V2V) charging.

According to an aspect of the present disclosure, an apparatus for V2V charging based on OCPP includes a supply equipment communication controller (SECC) based on ISO 15118, mounted on a vehicular Charging Station (VCS) for supplying energy for V2V charging and communicating with an electric vehicle for vehicle-to-vehicle (V2V) charging. The apparatus also may include an OCPP client (OCPP Cli) for communicating with the supply equipment communication controller (SECC), operating as an open charge point protocol (OCPP) client, and communicating with an OCPP server of a charging station management system (CSMS) for V2V charging management. The OCPP client executes an OCPP-based use case, reports a current status of the vehicular Charging Station (VCS) for V2V charging to the charging station management system (CSMS), and processes a response from the charging station management system (CSMS).

When a charging service provision is ready, the apparatus for V2V charging executes an OCPP-based GO6-VCSStatus (G06-Status Notification of VCS) use case, reports a current status of the vehicular Charging Station (VCS) to the charging station management system (CSMS) through a first VCS status report request message using the OCPP client, and receives the first VCS status report response message in response thereto. The first VCS status report request message includes a timestamp field, electric vehicle charging facility ID field, connector ID field, status field set to available, vehicular Charging Station (VCS) current location GPS location field, current charging status field, minimum charging status field, maximum available energy field, maximum traveling energy field, rate table field, charging specification field, connector type field, and support charging protocol field.

The apparatus for V2V charging accepts the V2V charging request, executes an OCPP-based G06-VCSStatus use case, reports a current status of the vehicular Charging Station (VCS) to the charging station management system (CSMS) through a second VCS status report request message using an OCPP client, and receives the second VCS status report response message in response thereto. The second VCS status report request message includes a timestamp field, electric vehicle charging facility ID field, connector ID field, V2V charging reservation status field, reserved electric vehicle information and type field, vehicular Charging Station current location GPS location field, and charging status field, maximum available energy field, and maximum traveling energy field.

When the apparatus for V2V charging is connected to the electric vehicle by a charging cable, the apparatus executes an OCPP-based G06-VCSStatus use case, reports a current status of the vehicular Charging Station to the charging station management system (CSMS) through a third VCS status report request message using the OCPP client, and receives the third VCS status report response message in response thereto. The third VCS status report request message includes a timestamp field, electric vehicle charging facility ID field, connector ID field, V2V charging usage status field, reserved electric vehicle information and type field, vehicular Charging Station current location GPS location field, and current charging status field, maximum available energy field, and maximum traveling energy field.

After a charging session is terminated and a transaction is terminated, the apparatus for V2V charging executes an OCPP-based GO6-VCSStatus (G06-status notification of (VCS) use case, reports a current status of the vehicular Charging Station (VCS) to the charging station management system (CSMS) through a fourth VCS status report request message using the OCPP client after completing the charging process, and receives the fourth VCS status report response message in response thereto. The fourth VCS status report request message includes a timestamp field, EV charging facility ID field, connector ID field, status field set to available, vehicular Charging Station (VCS) current location GPS location field, current charging status field, maximum available energy field, and maximum traveling energy field.

According to an aspect of the present disclosure, a V2V charging system based on OCPP includes an apparatus for V2V charging including a supply equipment communication controller (SECC) based on ISO 15118, mounted on a vehicular Charging Station supplying energy for V2V charging, and communicating with an electric vehicle for V2V charging, and an OCPP client (OCPP Cli) communicating with the supply equipment communication controller, operating as an open charge point protocol (OCPP) client, communicating with an OCPP server for V2V charging management, executing an OCPP-based use case, reporting a current status of the vehicular Charging Station (VCS) for V2V charging, and processing a response to the report. A charging station management system (CSMS) includes an OCPP server (OCPP Svr) operating as an OCPP server for the OCPP client and communicating with the charging apparatus for V2V charging management, and a CPO (Charging Point Operator) server (CPO Svr) communicating with the OCPP server and communicating with an authentication server to support V2V charging.

When charging service provision is ready, the apparatus for V2V charging executes an OCPP-based GO6-VCSStatus (G06-Status Notification of VCS) use case, reports a current status of the vehicular Charging Station (VCS) to the charging station management system (CSMS) through a first VCS status report request message using the OCPP client, and receives the first VCS status report response message in response thereto. The first VCS status report request message includes a timestamp field, electric vehicle charging facility ID field, connector ID field, status field set to available, vehicular Charging Station (VCS) current location GPS location field, current charging status field, minimum charging status field, maximum available energy field, maximum traveling energy field, rate table field, charging specification field, connector type field, and support charging protocol field.

The apparatus for V2V charging accepts the V2V charging request, executes an OCPP-based G06-VCSStatus use case, reports a current status of the vehicular Charging Station (VCS) to the charging station management system (CSMS) through a second VCS status report request message using the OCPP client, and receives the second VCS status report response message in response thereto. The second VCS status report request message includes a timestamp field, electric vehicle charging facility ID field, connector ID field, V2V charging reservation status field, reserved electric vehicle information and type field, vehicular Charging Station current location GPS location field, and charging status field, maximum available energy field, and maximum traveling energy field.

When the apparatus for V2V charging is connected to the electric vehicle by a charging cable, the apparatus executes an OCPP-based G06-VCSStatus use case, reports a current status of the vehicular Charging Station to the charging station management system (CSMS) through a third VCS status report request message using the OCPP client, and receives the third VCS status report response message in response thereto. The third VCS status report request message includes a timestamp field, electric vehicle charging facility ID field, connector ID field, V2V charging usage status field, reserved electric vehicle information and type field, vehicular Charging Station current location GPS location field, and current charging status field, maximum available energy field, and maximum traveling energy field.

After a charging session is terminated and a transaction is terminated, the apparatus for V2V charging executes an OCPP-based GO6-VCSStatus (G06-status notification of VCS) use case, reports a current status of the vehicular Charging Station (VCS) to the charging station management system (CSMS) through a fourth VCS status report request message using the OCPP client after completing the charging process, and receives the fourth VCS status report response message in response thereto. The fourth VCS status report request message includes a timestamp field, EV charging facility ID field, connector ID field, status field set to available, vehicular Charging Station (VCS) current location GPS location field, current charging status field, maximum available energy field, and maximum traveling energy field.

According to an aspect of the present disclosure, a method of V2V charging based on OCPP includes a charging preparation completion report operation of, when charging service provision is ready, executing an OCPP-based GO6-VCSStatus (G06-Status Notification of VCS) use case, reporting a current status of a vehicular Charging Station (VCS) to a charging station management system (CSMS) through a first VCS status report request message and receiving a first VCS status report response message by an apparatus for V2V charging, a charging reservation report operation of accepting a V2V charging request by the apparatus for V2V charging, executing an OCPP-based G06-VCSStatus use case, reporting a current status of the vehicular Charging Station (VCS) to the charging station management system (CSMS) through a second VCS status report request message using the OCPP client, and receiving the second VCS status report response message in response thereto, and a charging in-use status report operation of, when the apparatus for V2V charging is connected to the electric vehicle by a charging cable, executing an OCPP-based G06-VCSStatus use case, reporting a current status of the vehicular Charging Station to the charging station management system (CSMS) through a third VCS status report request message using the OCPP client, and receiving the third VCS status report response message in response thereto.

The method may further include a charging completion status report operation of executing an OCPP-based GO6-VCSStatus (G06-Status Notification of VCS) use case, reporting a current status of the vehicular Charging Station (VCS) through a fourth VCS status report request message to the charging station management system (CSMS) after terminating a charging process, and receiving the fourth VCS status report response message.

The first VCS status report request message includes a timestamp field, electric vehicle charging facility ID field, connector ID field, status field set to available, vehicular Charging Station (VCS) current location GPS location field, current charging status field, minimum charging status field, maximum available energy field, maximum traveling energy field, rate table field, charging specification field, connector type field, and support charging protocol field.

The second VCS status report request message includes a timestamp field, electric vehicle charging facility ID field, connector ID field, V2V charging reservation status field, reserved electric vehicle information and type field, vehicular Charging Station current location GPS location field, and charging status field, maximum available energy field, and maximum traveling energy field.

The third VCS status report request message includes a timestamp field, electric vehicle charging facility ID field, connector ID field, V2V charging usage status field, reserved electric vehicle information and type field, vehicular Charging Station current location GPS location field, and current charging status field, maximum available energy field, and maximum traveling energy field.

The fourth VCS status report request message includes a timestamp field, EV charging facility ID field, connector ID field, status field set to available, vehicular Charging Station (VCS) current location GPS location field, current charging status field, maximum available energy field, and maximum traveling energy field.

### BRIEF DESCRIPTION OF THE FIGURES

The above and other aspects and features of the present disclosure will be understood from the following detailed description, taken in conjunction with the accompanying figures, in which:

FIG. 1 is a diagram illustrating configuration of an apparatus for V2V charging according to an example embodiment of the present disclosure;

FIG. 2 is a diagram illustrating a configuration of a V2V charging system according to an example embodiment of the present disclosure;

FIG. 3 is a diagram illustrating a charging preparation completion report operation between an apparatus for V2V charging and a charging station management system according to an example embodiment of the present disclosure;

FIG. 4 is a diagram illustrating a charging reservation report operation between an apparatus for V2V charging and a charging station management system according to an example embodiment of the present disclosure;

FIG. 5 is a diagram illustrating a charging in-use state report operation between an apparatus for V2V charging and a charging station management system according to an example embodiment of the present disclosure;

FIG. 6 is a diagram illustrating a charging completion state report operation between an apparatus for V2V charging and a charging station management system according to an example embodiment of the present disclosure;

FIG. 7 is a flowchart illustrating a method of V2V charging according to an example embodiment of the present disclosure;

FIG. 8 is a diagram illustrating a general use case and charging operation based on OCPP for V2V charging according to an example embodiment of the present disclosure;

FIG. 9 is a diagram illustrating a charging completion state report operation according to an example embodiment of the present disclosure;

FIG. 10 is a description table for a G06 VCS state report request message;

FIG. 11 is a diagram illustrating a first VCS state report request (VCSStatusNotificationReq1) message based on OCPP according to an example embodiment of the present disclosure;

FIG. 12 is a diagram illustrating a second VCS state report request (VCSStatusNotificationReq2) message based on OCPP according to an example embodiment of the present disclosure;

FIG. 13 is a diagram illustrating a third VCS state report request (VCSStatusNotificationReq3) message based on OCPP according to an example embodiment of the present disclosure;

FIG. 14 is a diagram illustrating a fourth VCS state report request (VCSStatusNotificationReq4) message based on OCPP according to an example embodiment of the present disclosure; and

FIG. 15 is a block diagram illustrating a computing device which may (e.g., fully or partially) implement an apparatus, a system, and a method for vehicle-to-vehicle charging according to an example embodiment of the present disclosure.

### DETAILED DESCRIPTION

Hereinafter, specific embodiments of the present disclosure are described with reference to the accompanying figures. The following detailed description is provided to aid in an understanding of a method, a device and/or a system described in the present specification. However, the detailed description is for illustrative purposes, and the present disclosure is not limited thereto.

In describing the embodiments of the present disclosure, when it is determined that a detailed description of a known technology related to the present disclosure may obscure the gist of the present disclosure, the detailed description thereof may not be provided. Also, terms to be described below are terms defined in consideration of functions in the present disclosure, which may vary depending on intention or the custom of a user or operator. Accordingly, the definition of these terms may be made based on the contents throughout the present specification. The terminology used herein is for the purpose of describing particular embodiments and is not to be limiting of the embodiments. As used herein, the singular forms “a,” “an,” and “the” are intended to include the plural forms as well, unless the context indicates otherwise. As used herein, the term “and/or” includes one and any combination of any two or more of the associated listed items. It may be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

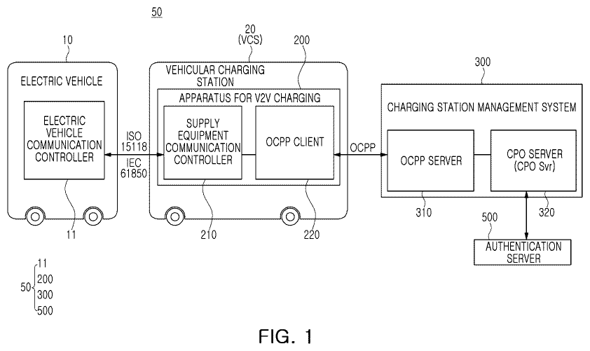

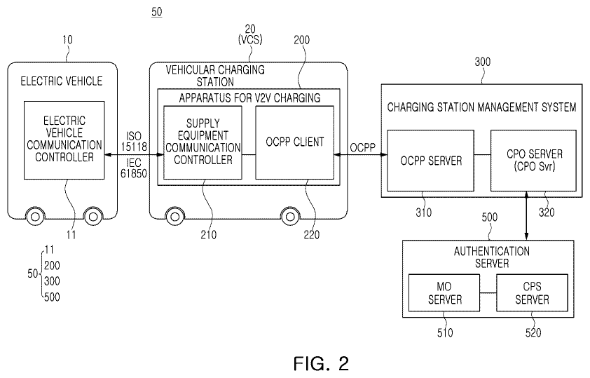

FIG. 1 is a diagram illustrating configuration of an apparatus for V2V charging according to an example embodiment. FIG. 2 is a diagram illustrating configuration of a V2V charging system according to an example embodiment.

Referring to FIG. 1 and FIG. 2, a V2V charging system 50 according to an example embodiment may include an apparatus for V2V charging 200 and a charging station management system 300 (CSMS).

An apparatus for V2V charging 200 may include a supply equipment communication controller 210 (SECC) and an OCPP client 220 (OCPP Cli).

The supply equipment communication controller 210 (SECC) may be a supply equipment communication controller based on ISO 15118 (or ISO 15118-2, hereinafter referred to as ISO 15118) for communicating with an electric vehicle 10 for V2V charging, and may be mounted on a vehicular Charging Station 20 (VCS) supplying energy for V2V charging.

The OCPP client 220 (OCPP Cli) may communicate with the supply equipment communication controller 210, may operate as an open charge point protocol (OCPP) client, may communicate with an OCPP server for V2V charging management, may execute an OCPP-based use case, may report a current status of the vehicular Charging Station (VCS) for V2V charging, and may process a response to the report.

The charging station management system 300 (CSMS) may include an OCPP server 310 (OCPP Svr) and a CPO server 320 (CPO Svr).

The OCPP server 310 (OCPP Svr) may be a supply equipment communication controller operating as an OCPP server for the OCPP client 220 and communicating with the apparatus for V2V charging 200 for V2V charging management.

The CPO server 320 (CPO Svr) may be a supply equipment communication controller for communicating with the OCPP server 310 and communicating with the certificate (e.g., authentication) server 500 to support V2V charging.

In example embodiments, each of the supply equipment communication controller 210 and the OCPP client 220 may be implemented as individual processors or may be implemented as a single integrated processor, and is not specifically limited thereto.

The electric vehicle 10 may include an electric vehicle communication controller 11 for performing ISO 15118-based communication with the supply equipment communication controller 210 of the vehicular Charging Station 20. Accordingly, the electric vehicle 10 may perform ISO 15118-based communication with the supply equipment communication controller 210 of the vehicular Charging Station 20 through the electric vehicle communication controller 11. Also, in example embodiments, the electric vehicle 10 may be connected to each other through a vehicular Charging Station 20 and a charging cable according to the IEC 61850 standard.

For example, each of the supply equipment communication controller 210 and the OCPP client 220 may be implemented as hardware element(s) or software element(s) or a combination thereof in at least one integrated circuit (IC) embedded in the apparatus for V2V charging 200, although the example embodiment is not limited thereto.

Also, in example embodiments, each of the OCPP server 310 and the CPO server 320 may be implemented as individual processors, or may be implemented as an integrated processor, and the example embodiment is not limited thereto.

Also, each of the supply equipment communication controller 210 (SECC) and the OCPP client 220 (OCPP Cli) may be implemented as hardware element(s) or software element(s) or a combination thereof in at least one integrated circuit (IC) embedded in the charging station management system 300, although the example embodiment is not limited thereto.

Generally, an OCPP-based use case may include (e.g., be a scenario including) a series of messages or data communications until an action entity completes an action to achieve a predetermined purpose. In example embodiments, as for the GO6 use case, the action subject may be a vehicular Charging Station (VCS) or a charging station management system (CSMS), and as for the action, for example, when the vehicular Charging Station (VCS) changes a status thereof (e.g., available, reserved, and occupied) for V2V charging or charging payment (PnC), or at a specific interval, the vehicular Charging Station (VCS) sends a VCS status report request (VCSStatusNotificationReq) message to the charging station management system (CSMS), and when the charging station management system (CSMS) receives the VCS status report request (VCSStatusNotificationReq) message from the vehicular Charging Station (VCS), the vehicular Charging Station (VCS) sends a VCS status report response (VCSStatusNotificationRes) message in response. The use case may include message communication, including such information, until the purpose is achieved.

For each figure of the example embodiment, redundant descriptions of components with the same reference numeral and function may not be provided, although possible differences may be described for each figure.

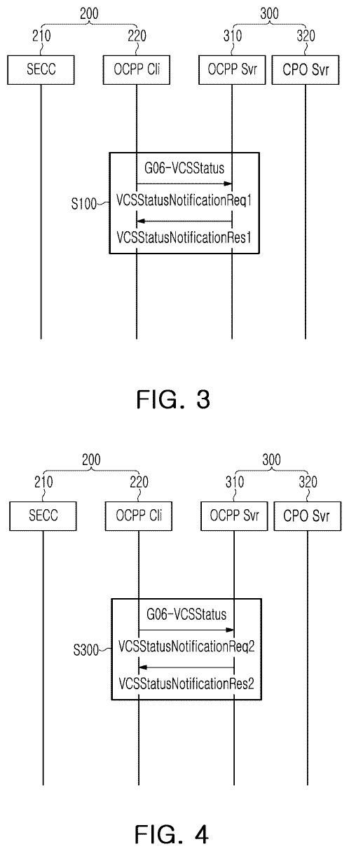

FIG. 3 is a diagram illustrating a charging preparation completion report operation between an apparatus for V2V charging and a charging station management system according to an example embodiment.

Referring to FIG. 3, when charging service provision preparation is completed, the apparatus for V2V charging 200 may execute an OCPP-based GO6-VCSStatus (G06-Status Notification of VCS) use case, may report the current status of the vehicular Charging Station (VCS) to the charging station management system 300 (CSMS) through the first VCS status report request (VCSStatusNotificationReq1) message using the OCPP client 220, and may receive the first VCS status report response (VCSStatusNotificationRes1) message in response.

In this case, the charging station management system 300 (CSMS) may transmit a first VCS status report response (VCSStatusNotificationRes1) message, which is a response message to the first VCS status report request (VCSStatusNotificationReq1), to the vehicular Charging Station (VCS) using the OCPP server 310.

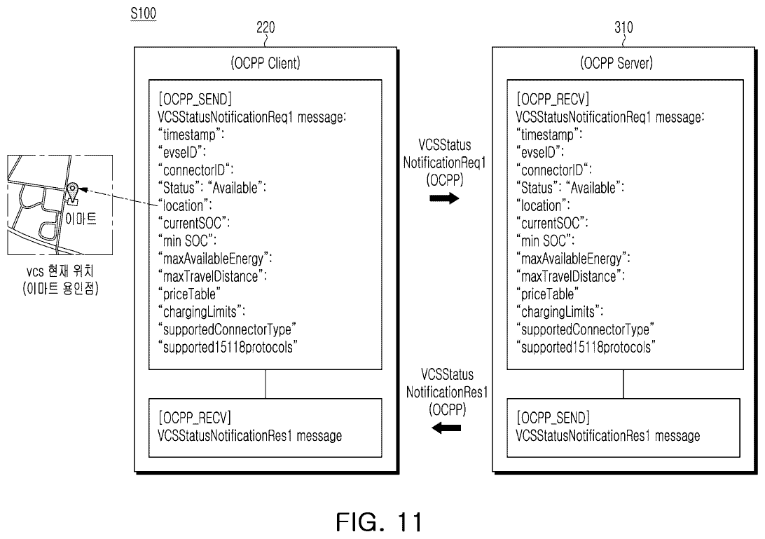

The first VCS status report request (VCSStatusNotificationReq1) message and the first VCS status report response (VCSStatusNotificationRes1) message are described herein with reference to FIG. 11.

FIG. 4 is a diagram illustrating a charging reservation report operation between an apparatus for V2V charging and a charging station management system according to an example embodiment.

Referring to FIG. 4, after accepting the V2V charging request, the apparatus for V2V charging 200 may execute an OCPP-based G06-VCSStatus use case, may report a current status of the vehicular Charging Station (VCS) to the charging station management system 300 (CSMS) through a second VCS status report request (VCSStatusNotificationReq2) message using the OCPP client 220, and may receive a second VCS status report response (VCSStatusNotificationRes2) message in response to the second VCS status report request (VCSStatusNotificationReq2) message.

In this case, the charging station management system 300 (CSMS) may transmit a second VCS status report response (VCSStatusNotificationRes2) message, which is a response message to the second VCS status report request (VCSStatusNotificationReq2), to the vehicular Charging Station (VCS) using the OCPP server 310.

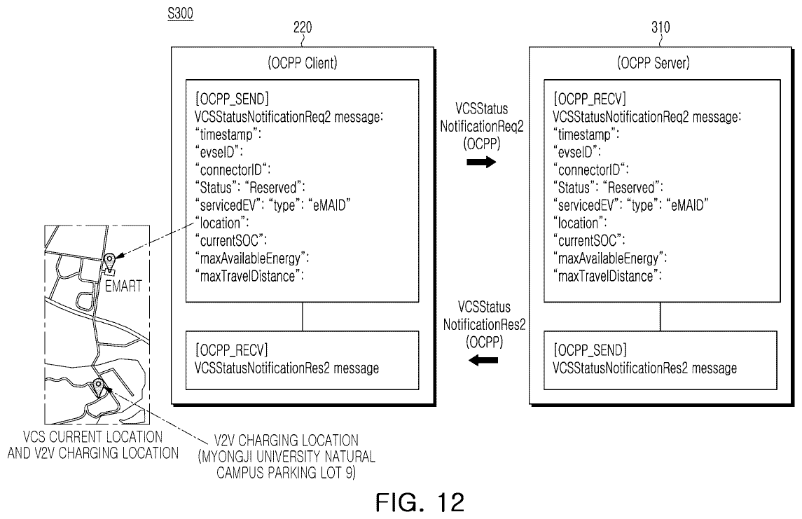

The second VCS status report request (VCSStatusNotificationReq2) message and the second VCS status report response (VCSStatusNotificationRes2) message is described herein with reference to FIG. 12.

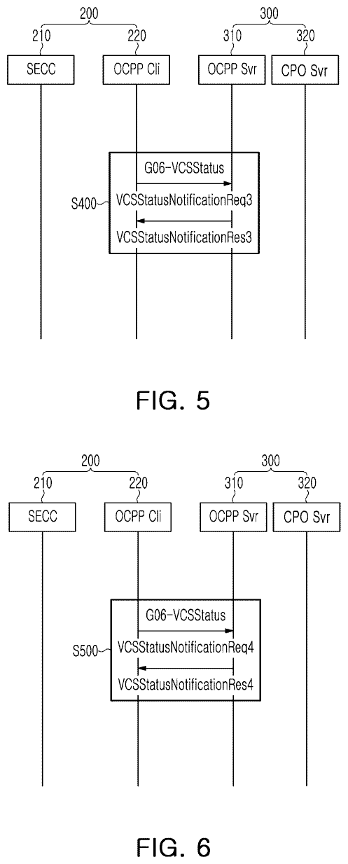

FIG. 5 is a diagram illustrating a charging in-use state report operation between an apparatus for V2V charging and a charging station management system according to an example embodiment.

Referring to FIG. 5, when an apparatus for V2V charging 200 is connected to the electric vehicle 10 using a charging cable, the apparatus for V2V charging 200 may execute an OCPP-based G06-VCSStatus use case, and may report a current status of a vehicular Charging Station (VCS) to the charging station management system 300 (CSMS) through a third VCS status report request (VCSStatusNotificationReq3) message using the OCPP client 220, and may receive a third VCS status report response (VCSStatusNotificationRes3) message in response thereto.

In this case, the charging station management system 300 (CSMS) may transmit a third VCS status report response (VCSStatusNotificationRes3) message, which is a response message to a third VCS status report request (VCSStatusNotificationReq3), to the vehicular Charging Station (VCS) using the OCPP server 310.

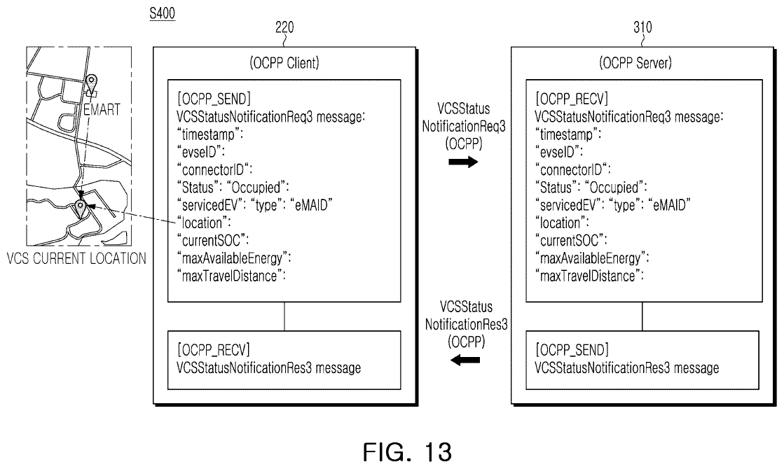

The third VCS status report request (VCSStatusNotificationReq3) message and the third VCS status report response (VCSStatusNotificationRes3) message is described herein with reference to FIG. 13.

FIG. 6 is a diagram illustrating a charging completion state report operation between an apparatus for V2V charging and a charging station management system according to an example embodiment.

Referring to FIG. 6, after the charging session ends and the transaction ends, the apparatus for V2V charging 200 may execute an OCPP-based GO6-VCSStatus (G06-Status Notification of VCS) use case, and after the charging process ends, using the OCPP client 220, the charging station management system 300 (CSMS) may report a current status of the vehicular Charging Station (VCS) through the fourth VCS status report request (VCSStatusNotificationReq4) message using the OCPP client 220, and may receive the fourth VCS status report response (VCSStatusNotificationRes4) message in response thereto.

In this case, the charging station management system 300 (CSMS) may transmit a fourth VCS status report response (VCSStatusNotificationRes4) message, which is a response message to the fourth VCS status report request (VCSStatusNotificationReq4), to the vehicular Charging Station (VCS) using the OCPP server 310.

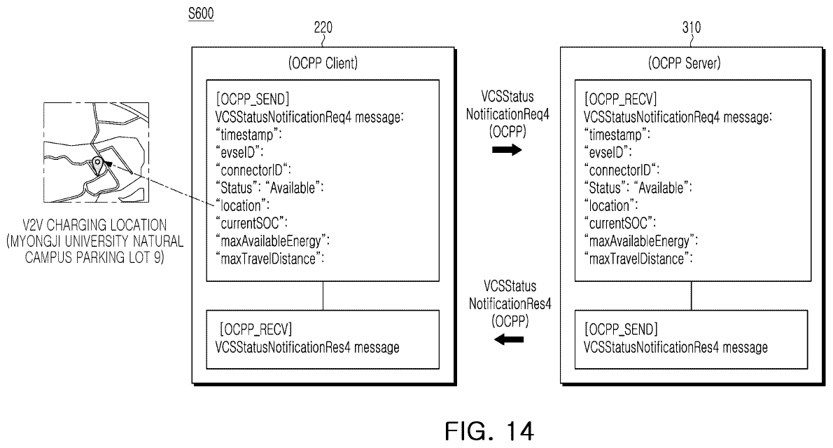

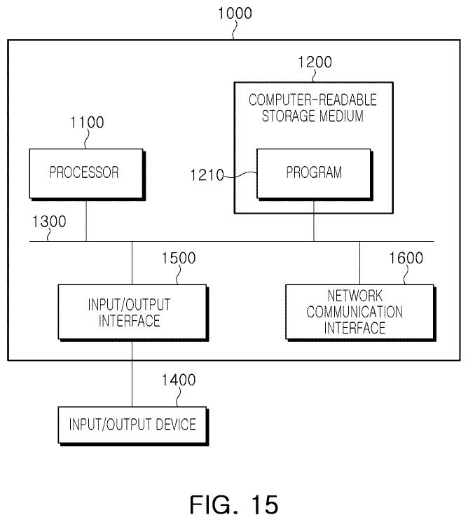

The fourth VCS status report request (VCSStatusNotificationReq4) message and the fourth VCS status report response (VCSStatusNotificationRes1) message is described herein with reference to FIG. 14.

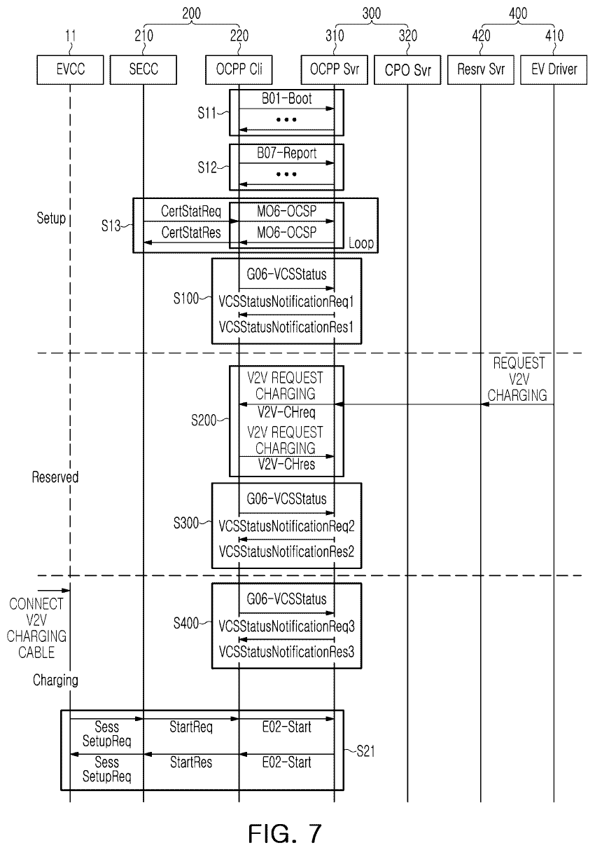

Hereinafter, the method of V2V charging will be described with reference to FIGS. 7 to 14. In example embodiments, the description of the method of V2V charging and the description of V2V charging neglect may be complementary or commonly applied, unless otherwise indicated. Accordingly, overlapping descriptions may not be provided. Hereinafter, the main process of the method of V2V charging will be described.

FIG. 7 is a flowchart illustrating a method of V2V charging according to an example embodiment.

Referring to FIG. 2 and FIG. 7, the method of V2V charging according to an embodiment of the disclosure may be performed by a V2V charging system (50, see FIG. 2).

The method of V2V charging may include a charging preparation completion report operation (S100), a charging reservation report operation (S300), and a charging in-use status report operation (S400). Here, a charging reservation report operation (S200) may be performed between the charging preparation completion report operation (S100) and the charging reservation report operation (S300).

In the charging preparation completion report operation (S100), when the apparatus for V2V charging 200 is ready for charging service provision, the apparatus for V2V charging 200 may execute OCPP-based GO6-VCSStatus (G06-Status Notification of VCS) use case using the OCPP client 220, may report the current status of the vehicular Charging Station (VCS) to the charging station management system 300 (CSMS) through the first VCS status report request (VCSStatusNotificationReq1) message, and may receive the first VCS status report response (VCSStatusNotificationRes1) message from the charging station management system 300 (CSMS) through the OCPP server 310 in response thereto.

In the charging reservation report operation (S200), the apparatus for V2V charging 200 may receive a V2V charging request (V2V-CHreq) message from the charging station management system 300 (CSMS) using the OCPP client 220, and may send a charging response (V2V-CHres) message including acceptance information and expected charge information to the charging station management system 300 (CSMS) in response thereto.

When a charging reservation is requested to the charging reservation server 420 through the V2V charging application for reserving charging at the electric vehicle driver terminal 410, the charging station management system 300 (CSMS) may receive a V2V request (V2V-CHreq) message from the charging reservation server 420 and may transfer the V2V request (V2V-CHreq) message to the apparatus for V2V charging 200 as described above.

After, in the charging reservation report operation (S300), after the apparatus for V2V charging 200 accepts the V2V charging request, the apparatus for V2V charging 200 may execute the OCPP-based G06-VCSStatus (G06-Status Notification of VCS) use case using the OCPP client 220, may report the current status of the vehicular Charging Station (VCS) to the charging station management system 300 (CSMS) through a second VCS status report request (VCSStatusNotificationReq2) message, and may receive the second VCS status report response (VCSStatusNotificationRes2) message from the charging station management system 300 (CSMS) through the OCPP server 310 in response thereto.

In the charging in-use status report operation (S400), when the apparatus for V2V charging 200 is connected to the electric vehicle 10 with a charging cable, the apparatus for V2V charging 200 may execute the OCPP-based G06-VCSStatus (G06-Status Notification of VCS) use case using the OCPP client 220, may report the current status of the vehicular Charging Station (VCS) to the charging station management system 300 (CSMS) through a third VCS status report request (VCSStatusNotificationReq3) message, and may receive the third VCS status report response (VCSStatusNotificationRes3) message from the charging station management system 300 (CSMS) through the OCPP server 310 in response thereto.

Thereafter, after performing the charging in-use status report operation (S400) according to the example embodiment, the charging session generation operation (S21) corresponding to the existing OCPP-based use case may be performed.

In the charging session generation operation (S21), the apparatus for V2V charging 200 may generate a charging session and OCPP transaction based on ISO 15118-2 to start the V2V charging process, may execute an OCPP-based E02-Start use case, may transmit a ‘VCS Start Transaction-Cable Plugin First’ request message, and may receive a ‘VCS Start Transaction-Cable Plugin First’ response message in response thereto.

For example, the OCPP client 220 of the apparatus for V2V charging 200 may receive a start request (StartReq) message from the supply equipment communication controller 210 having received a charging session set-up request (SeeSetupReq) message from the electric vehicle communication controller 11 (EVCC) of the electric vehicle (10, see FIG. 2), and may execute an OCPP-based E02-Start use case. The OCPP client 220 of the apparatus for V2V charging 200 may receive the ‘VCS Start Transaction-Cable Plugin First’ response message, and the supply equipment communication controller 210 may send a charging session set-up response (SeeSetupRes) message to the electric vehicle communication controller 11 (EVCC) in response thereto.

Before the charging preparation completion report operation (S100) according to the example embodiment, a pre-verification operation for V2V charging may be performed, and the pre-verification operation may include an initial setting operation (S11), an OCPP client setting operation (S12), and an OCSP-based validation operation (S13).

The initial setting operation (S11), the OCPP client setting operation (S12) and the OCSP-based validation operation (S13) may correspond to an existing OCPP-based use case, and thus, more detailed descriptions may not be provided.

First, in the initial setting operation (S11), the apparatus for V2V charging 200 may execute the OCPP-based B01-Bootuse case, may transmit a report message reporting initial boot completion and connector availability to the charging station management system 300 (CSMS) as an initial setting process for V2V charging, and may receive a response message thereto.

Thereafter, in the OCPP client setting operation (S12), the apparatus for V2V charging 200 may execute the OCPP-based B07-Reportuse case, may transmit a report message reporting OCPP client setting information including heartbeat cycle, applicable currency, and connector information, to the charging station management system 300 (CSMS) and may receive a response message in response thereto.

In the OCSP-based validation operation (S13), the OCPP client 220 of the apparatus for V2V charging 200 may execute an OCPP-based M06-OCSPuse case according to an ISO 15118-based certificate verification request (CertStatReg) message from the supply equipment communication controller 210, may transmit a request message requesting OCSP-based validation for a certificate chain of an ISO 15118-2-based charging apparatus to the charging station management system 300 (CSMS), may receive a response message thereto, and may send an ISO 15118-based certificate verification response (CertStatRes) message to the supply equipment communication controller 210 based on the message.

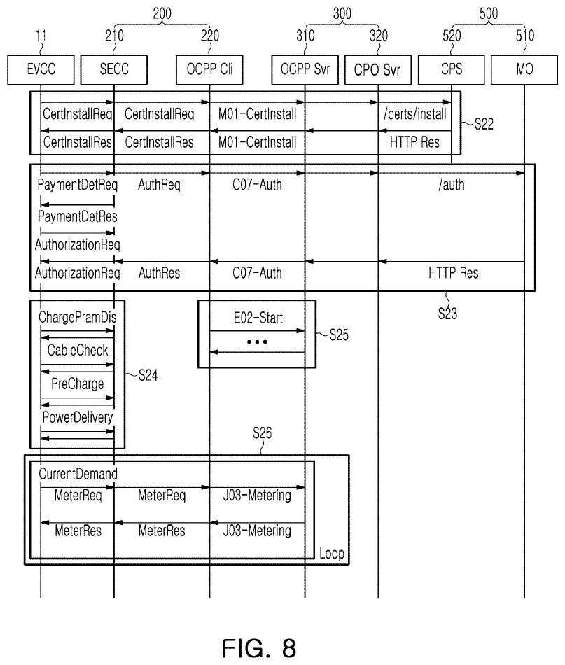

FIG. 8 is a diagram illustrating a general use case and charging operation based on OCPP for V2V charging according to an example embodiment.

Referring to FIG. 8, after the charging session generation operation (S21) described above is performed, a certificate installation (EV) operation (S22), an authorization using contract certificates operation (S23), an OCPP start transaction-cable plugin first operation (S24), an ISO 15118-2 charging (V2V charging) operation (S25), and a charging loop with metering information exchange operation (S26) may be performed in order using the existing OCPP-based use case.

The certificate installation (EV) operation (S22), authorization using contract certificates operation (S23), OCPP start transaction-cable plugin first operation (S24), ISO 15118-2 charging (V2V Charging) operation (S25), and charging loop with metering information exchange operation (S26) may correspond to the existing OCPP use case.

First, in the certificate installation (EV) operation (S22), the OCPP client 220 of the apparatus for V2V charging 200 may receive a certificate installation request (CertInstallReq) message from the electric vehicle communication controller 11 (EVCC) through the supply equipment communication controller 210, may execute an OCPP-based M01-CertInstall (M01-Certificate installation EV) use case, may transmit a request message requesting certificate installation in the case in which no valid certificate is present according to the certificate request from the electric vehicle 10 (EVCC), may receive a response message thereto, and may transmit a certificate installation response (CertInstallRes) message to the electric vehicle communication controller 11 of the electric vehicle 10 through the supply equipment communication controller 210.

The charging station management system 300 (CSMS) may receive a request message regarding certificate installation from the apparatus for V2V charging 200 through the OCPP server 310, which is an OCPP server, may request certificate installation to the CPS 520 of the certificate server 500 managing the certificate through the CPO server 320, which is a CPO (Charging Point Operator) server, may receive a response message (HTTP Res) thereto, may execute the OCPP-based M01-CertInstall use case through the OCPP server 310 and may transmit the response message as described above to the apparatus for V2V charging 200. The certificate provisioning service (CPS) server 520 may verify the customer who requested the certificate installation, and in the case in which the customer is a valid customer, the certificate provisioning service (CPS) server 520 may transmit the response message (HTTP Res) including information that the customer is a valid customer.

Thereafter, in the authorization using contract certificates operation (S23), the OCPP client 220 of the apparatus for V2V charging 200 may perform a match verification between the electric vehicle identifier information (servicesdEV, eMAID) of the contract certificate and the electric vehicle identifier information (servicesdEV, eMAID) of the charging request for the contract certificate chain received from the electric vehicle communication controller 11 of the electric vehicle 10 (EVCC) through the payment request (PaymentDetReq) message, may execute an OCPP-based C07-Auth (authorization using contract certificates (PnC)) use case and may transmit a verification request message for the contract certificate to the charging station management system 300 (CSMS).

In response thereto, the OCPP client 220 of the apparatus for V2V charging 200 may receive a response message including chain verification information of the contract certificate chain and validation information for the electric vehicle identifier information (servicesdEV, eMAID) of the contract certificate, and may transmit an authorization response (AuthorizationRes) message to the electric vehicle communication controller 11 of the electric vehicle 10 as a response to the payment request (PaymentDetReq) message.

In this case, the charging station management system 300 (CSMS) may perform chain verification of the contract certificate chain, and the MO (e-mobility service provider) server 510 of the certificate server 500 may perform validation for the electric vehicle identifier information (servicesdEV, eMAID) of the contract certificate, and may transmit a message including each verification result information to the apparatus for V2V charging 200.

Thereafter, in the OCPP start transaction-cable plugin first operation (S24), the apparatus for V2V charging 200 may execute an OCPP-based E02-Start (start transaction-cable plugin first) use case, may transmit an OCPP transaction initiation request message to a charging station management system 300 (CSMS) and may receive a response message thereto.

Thereafter, in the ISO 15118-2 charging (V2V Charging) operation (S25), the apparatus for V2V charging 200 may start a V2V charging process through an IEC 61850-based charging cable while performing ISO 15118-2-based communication for the electric vehicle 10.

In the charging loop with metering information exchange operation (S26), while performing the V2V charging, the apparatus for V2V charging 200 may execute the OCPP-based J03-Metering (charging loop with metering information exchange) use case, may transmit a metering information request (MeteringReceiptReg) message from the electric vehicle 10 (EVCC) to the charging station management system 300 (CSMS), may receive a response message thereto and may transfer the response message to the electric vehicle 10 (EVCC).

The charging station management system 300 (CSMS) may record the entirety of status information collected from the vehicular Charging Station (VCS) from the start of charging to the end of charging for each transaction.

Also, the charging station management system 300 (CSMS) may manage the entirety of information collected through the vehicular Charging Station (VCS) as a history for each vehicular Charging Station (VCS), and based on the history information of each vehicular Charging Station (VCS), the status for each vehicular Charging Station (VCS) may be identified and managed.

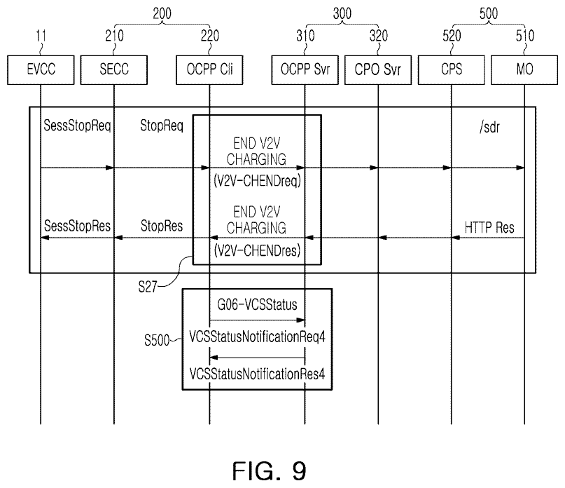

FIG. 9 is a diagram illustrating a charging completion state report operation according to an example embodiment.

Referring to FIG. 9, after performing a charging loop with metering information exchange operation (S26), a charging stop operation (S27) may be performed.

In the charging stop operation (S27), the charging apparatus 200 (SECC+OCPP Cli) may transmit a request message including charging session termination and transaction termination information to the charging station management system 300 (CSMS) using the OCPP client 220 (OCPP Cli) according to a charging stop request <SessStopReq> received from the electric vehicle 10 (EVCC), and may receive a response message thereto and may transmit the response message to the electric vehicle 10.

In the charging completion status report operation (S500), the apparatus for V2V charging 200 may execute an OCPP-based GO6-VCSStatus (G06-Status Notification of VCS) use case using the OCPP client 220 after the charging session ends and the transaction ends, may report the current status of the vehicular Charging Station (VCS) to the charging station management system 300 (CSMS) through a fourth VCS status report request (VCSStatusNotificationReq4) message after the charging process ends, and may receive a fourth VCS status report response (VCSStatusNotificationRes4) message from the charging station management system 300 (CSMS) through the OCPP server 310.

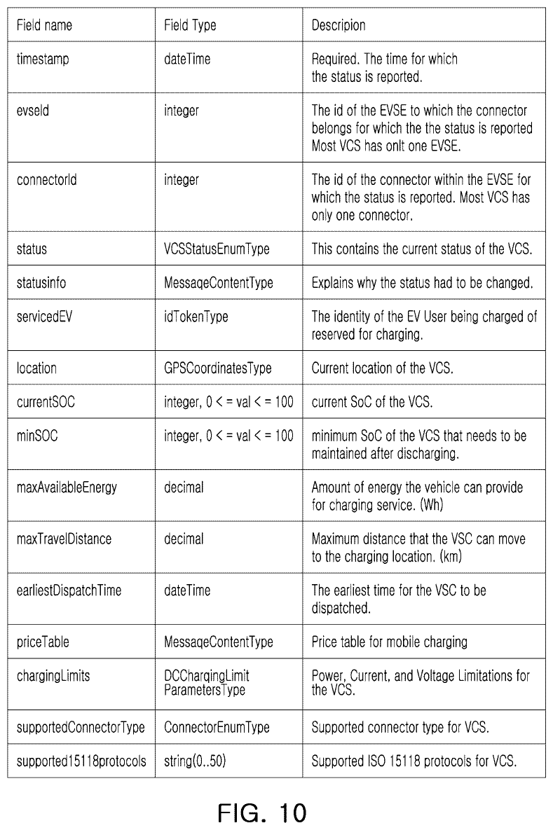

FIG. 10 is a description table for a G06 VCS state report request message.

The table illustrated in FIG. 10 is a table describing a VCS status report request message for the OCPP-based GO6-VCSStatus (G06-Status Notification of VCS) use case.

Referring to the table illustrated in FIG. 10, the first row may be a field name for each of a plurality of fields, the second row may be a field type indicating whether the field is a date type, an integer, a decimal number, or the like,, and the third row may be descriptions.

For example, in timestamp, a field type may be dateTime,, a description may be a required field, and the description indicates the time at which the status is reported.

FIG. 11 is a diagram illustrating a first VCS state report request (VCSStatusNotificationReq1) message based on OCPP according to an example embodiment.

Referring to FIG. 11, the first VCS status report request (VCSStatusNotificationReq1) message may include a timestamp field, an electric vehicle charging facility ID (evseID) field, a connector ID (connectorID) field, a status (status) field set to available, a vehicular Charging Station (VCS) current location GPS location (location) field, a current charging status (currentSOC) field, a minimum charging status (min SOC) field, a maximum available energy (maxAvailableEnergy) field, a maximum traveling energy energy (maxTravelDistance) field, a rate table (priceTable) field, a charging specification (chargingLimits) field, a connector type (supportedConnectorType) field, and a support charging protocol (supported15118protocols) field.

FIG. 12 is a diagram illustrating a second VCS state report request (VCSStatusNotificationReq2) message based on OCPP according to an example embodiment.

Referring to FIG. 12, the second VCS status report request (VCSStatusNotificationReq2) message may include a timestamp field, an electric vehicle charging facility ID (evseID) field, a connector ID (connectorID) field, a V2V charging reserved status (Reserved) field, reserved electric vehicle information (servicedEV) and type (type: eMAID) field, a vehicular Charging Station (VCS) current location GPS location (location) field, and a charging status (currentSOC) field, a maximum available energy (maxAvailableEnergy) field, and a maximum traveling energy energy (maxTravelDistance) field.

FIG. 13 is a diagram illustrating a third VCS state report request (VCSStatusNotificationReq3) message based on OCPP according to an example embodiment.

Referring to FIG. 13, the third VCS status report request (VCSStatusNotificationReq3) message may include a timestamp field, an electric vehicle charging facility ID (evseID) field, a connector ID (connectorID) field, a V2V charging status (Occupied) field, a reserved electric vehicle information (servicedEV) and type (type: eMAID) field, a vehicular Charging Station (VCS) current location GPS location field, and a current charging status (currentSOC) field, a maximum available energy (maxAvailableEnergy) field, and a maximum traveling energy energy (maxTravelDistance) field.

FIG. 14 is an example diagram illustrating a fourth VCS state report request (VCSStatusNotificationReq4) message based on OCPP according to an example embodiment.

Referring to FIG. 14, the fourth VCS status report request (VCSStatusNotificationReq4) message may include a timestamp field, an electric vehicle charging facility ID (evseID) field, a connectorID field, a status (Status) field set to available, a vehicular Charging Station (VCS) current location GPS location (location) field, a current charging status (currentSOC) field, a maximum available energy (maxAvailableEnergy) field, and a maximum traveling energy energy (maxTravelDistance) field.

FIG. 15 is a block diagram illustrating a computing device which may fully or partially implement an apparatus, a system and a method for vehicle-to-vehicle charging according to an example embodiment.

As illustrated in FIG. 15, a computing device 1000 may include at least one processor 1100, a computer-readable storage medium 1200, and a communication bus 1300.

The processor 1100 may allow the computing device 1000 to operate according to the exemplary embodiments described above. For example, the processor 1100 may access and execute one or more programs stored in the computer-readable storage medium 1200. The one or more programs may include one or more computer-executable instructions, and the computer-executable instructions may be configured to allow the computing device 1000 to perform operations according to the exemplary embodiments when executed by the processor 1100.

The computer-readable storage medium 1200 may be configured to store computer-executable instructions, program code, program data, and/or other suitable forms of information. A program 1210 stored on a computer-readable storage medium 1200 may include a set of instructions executable by the processor 1100. In one embodiment, the computer-readable storage medium 1200 may be implemented as a memory (e.g., volatile memory such as random access memory, non-volatile memory, or a suitable combination thereof), one or more magnetic disk storage devices, optical disk storage devices, flash memory devices, any other form of storage medium for being accessed by the computing device 1000 and storing desired information, or a suitable combination thereof.

The communication bus 1300 may interconnect various other components of the computing device 1000, including the processor 1100, the computer-readable storage medium 1200.

The computing device 1000 may also include one or more input/output interfaces 1500 and one or more network communication interfaces 1600 providing interfaces for one or more input/output devices 1400. The input/output interface 1500 and the network communication interface 1600 may be connected to the communication bus 1300. The network may be implemented as a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), or another cellular network.

The input/output device 1400 may be connected to other components of the computing device 1000 through the input/output interface 1500. The example of the input/output device 1400 may include input devices such as a pointing device (such as a mouse or a trackpad), a keyboard, a touch input device (such as a touchpad or a touchscreen), a voice or sound input device, various types of sensor devices and/or photographing devices, and/or output devices such as a display device, a printer, a speaker, and/or a network card. The input/output device 1400 may be included in the computing device 1000 as a component included in the computing device 1000, or may be connected to the computing device 1000 as a separate device distinct from the computing device 1000.

The example embodiments of the present disclosure may include a program for performing the methods described herein on a computer, and a computer-readable recording medium including the program. The computer-readable recording medium may include program commands, local data files, local data structures, or the like, alone or in combination. The medium may be specially designed and configured for the present disclosure, or may be commonly available in the computer software field. Examples of the computer-readable recording medium may include magnetic media such as hard disks, floppy disks, and magnetic tapes, optical recording media such as CD-ROMs and DVDs, and hardware devices specially configured to store and execute program commands such as ROMs, RAMs, and flash memories. Examples of the program may include machine language codes generated by a compiler, and also high-level language codes executed by a computer using an interpreter, or the like.

According to the example embodiments herein, in order to support payable V2V charging, by suggesting a new use case based on OCPP to provide (e.g., enable) communication and status monitoring between the vehicular Charging Station (VCS) and the charging station management system (CSM), a paid charging service may be provided and appropriate dispatching for the vehicular Charging Station may be available.

While embodiments have been illustrated and described above, it will be apparent to those skilled in the art that modifications and variations may be made without departing from the scope of the present disclosure as provided (e.g., defined) herein.

What is claimed is:

1. An apparatus for Vehicle to Vehicle (V2V) charging based on Open Charge Point Protocol (OCPP), the apparatus comprising:
a supply equipment communication controller (SECC) based on ISO 15118, mounted on a vehicular Charging Station (VCS) for supplying energy for V2V charging and communicating with an electric vehicle for vehicle-to-vehicle (V2V) charging; and
an OCPP client (OCPP Cli) for communicating with the supply equipment communication controller (SECC), operating as an open charge point protocol (OCPP) client, and communicating with an OCPP server of a charging station management system (CSMS) for V2V charging management,
wherein the OCPP client executes an OCPP-based use case, reports a current status of the vehicular Charging Station (VCS) for V2V charging to the charging station management system (CSMS), and processes a response from the charging station management system (CSMS).

2. The apparatus of claim 1,
wherein, when charging service provision is ready, the apparatus for V2V charging executes an OCPP-based GO6-VCSStatus (G06-Status Notification of VCS) use case, reports a current status of the vehicular Charging Station (VCS) to the charging station management system (CSMS) through a first VCS status report request message using the OCPP client, and receives a first VCS status report response message in response thereto.

3. The apparatus of claim 2,
wherein the first VCS status report request message includes a timestamp field, electric vehicle charging facility ID field, connector ID field, status field set to available, vehicular Charging Station (VCS) current location GPS location field, current charging status field, minimum charging status field, maximum available energy field, maximum traveling energy field, rate table field, charging specification field, connector type field, and support charging protocol field.

4. The apparatus of claim 1,
wherein the apparatus for V2V charging accepts a V2V charging request, executes an OCPP-based G06-VCSStatus use case, reports a current status of the vehicular Charging Station (VCS) to the charging station management system (CSMS) through a second VCS status report request message using an OCPP client, and receives a second VCS status report response message in response thereto.

5. The apparatus of claim 4,
wherein the second VCS status report request message includes a timestamp field, electric vehicle charging facility ID field, connector ID field, V2V charging reservation status field, reserved electric vehicle information and type field, vehicular Charging Station current location GPS location field, and charging status field, maximum available energy field, and maximum traveling energy field.

6. The apparatus of claim 1,
wherein, when the apparatus for V2V charging is connected to the electric vehicle by a charging cable, the apparatus executes an OCPP-based G06-VCSStatus use case, reports a current status of the vehicular Charging Station to the charging station management system (CSMS) through a third VCS status report request message using the OCPP client, and receives a third VCS status report response message in response thereto.

7. The apparatus of claim 6,
wherein the third VCS status report request message includes a timestamp field, electric vehicle charging facility ID field, connector ID field, V2V charging usage status field, reserved electric vehicle information and type field, vehicular Charging Station current location GPS location field, and current charging status field, maximum available energy field, and maximum traveling energy field.

8. The apparatus of claim 1,
wherein, after a charging session is terminated and a transaction is terminated, the apparatus for V2V charging executes an OCPP-based GO6-VCSStatus (G06-status notification of (VCS) use case, reports a current status of the vehicular Charging Station (VCS) to the charging station management system (CSMS) through a fourth VCS status report request message using the OCPP client after completing the charging session, and receives a fourth VCS status report response message in response thereto.

9. The apparatus of claim 8,
wherein the fourth VCS status report request message includes a timestamp field, EV charging facility ID field, connector ID field, status field set to available, vehicular Charging Station (VCS) current location GPS location field, current charging status field, maximum available energy field, and maximum traveling energy field.

10. A V2V charging system based on OCPP, the V2V charging system comprising:
an apparatus for V2V charging including a supply equipment communication controller (SECC) based on ISO 15118, mounted on a vehicular Charging Station (VCS) supplying energy for V2V charging, and communicating with an electric vehicle for V2V charging, and an OCPP client (OCPP Cli)
communicating with the supply equipment communication controller, operating as an open charge point protocol (OCPP) client,
communicating with an OCPP server for V2V charging management,
executing an OCPP-based use case,
reporting a current status of the vehicular Charging Station (VCS) for V2V charging, and
processing a response to the report; and
a charging station management system (CSMS) including an OCPP server (OCPP Svr) operating as an OCPP server for the OCPP client and communicating with the apparatus for V2V charging management, and a CPO server (CPO Svr) communicating with the OCPP server and communicating with an authentication server to support V2V charging.

11. The V2V charging system of claim 10,
wherein, when charging service provision is ready, the apparatus for V2V charging executes an OCPP-based GO6-VCSStatus (G06-Status Notification of VCS) use case, reports a current status of the vehicular Charging Station (VCS) to the charging station management system (CSMS) through a first VCS status report request message using the OCPP client, and receives a first VCS status report response message in response thereto, and
wherein the first VCS status report request message includes a timestamp field, electric vehicle charging facility ID field, connector ID field, status field set to available, vehicular Charging Station (VCS) current location GPS location field, current charging status field, minimum charging status field, maximum available energy field, maximum traveling energy field, rate table field, charging specification field, connector type field, and support charging protocol field.

12. The V2V charging system of claim 10,
wherein the apparatus for V2V charging accepts a V2V charging request, executes an OCPP-based G06-VCSStatus use case, reports a current status of the vehicular Charging Station (VCS) to the charging station management system (CSMS) through a second VCS status report request message using the OCPP client, and receives a second VCS status report response message in response thereto, and
wherein the second VCS status report request message includes a timestamp field, electric vehicle charging facility ID field, connector ID field, V2V charging reservation status field, reserved electric vehicle information and type field, vehicular Charging Station current location GPS location field, and charging status field, maximum available energy field, and maximum traveling energy field.

13. The V2V charging system of claim 10,
wherein, when the apparatus for V2V charging is connected to the electric vehicle by a charging cable, the apparatus executes an OCPP-based G06-VCSStatus use case, reports a current status of the vehicular Charging Station (VCS) to the charging station management system (CSMS) through a third VCS status report request message using the OCPP client, and receives a third VCS status report response message in response thereto, and
wherein the third VCS status report request message includes a timestamp field, electric vehicle charging facility ID field, connector ID field, V2V charging usage status field, reserved electric vehicle information and type field, vehicular Charging Station current location GPS location field, and current charging status field, maximum available energy field, and maximum traveling energy field.

14. The V2V charging system of claim 10,
wherein, after a charging session is terminated and a transaction is terminated, the apparatus for V2V charging executes an OCPP-based GO6-VCSStatus (G06-status notification of VCS) use case, reports a current status of the vehicular Charging Station (VCS) to the charging station management system (CSMS) through a fourth VCS status report request message using the OCPP client after completing the charging session, and receives a fourth VCS status report response message in response thereto, and
wherein the fourth VCS status report request message includes a timestamp field, EV charging facility ID field, connector ID field, status field set to available, vehicular Charging Station (VCS) current location GPS location field, current charging status field, maximum available energy field, and maximum traveling energy field.

15. A method of V2V charging based on OCPP, the method comprising:
executing an OCPP-based GO6-VCSStatus (G06-Status Notification of VCS) use case for a charging preparation completion reporting when charging service provision is ready, reporting a current status of a vehicular Charging Station (VCS) to a charging station management system (CSMS) through a first VCS status report request message and receiving a first VCS status report response message by an apparatus for V2V charging;
executing an OCPP-based G06-VCSStatus use case for a charging reservation reporting after accepting a V2V charging request by the apparatus for V2V charging, reporting a current status of the vehicular Charging Station (VCS) to the charging station management system (CSMS) through a second VCS status report request message using an OCPP client, and receiving a second VCS status report response message in response thereto; and
executing an OCPP-based G06-VCSStatus use case for a charging in-use status reporting when the apparatus for V2V charging is connected to an electric vehicle by a charging cable, reporting a current status of the vehicular Charging Station to the charging station management system (CSMS) through a third VCS status report request message using the OCPP client, and receiving a third VCS status report response message in response thereto.

16. The method of claim 15, further comprising:
executing an OCPP-based GO6-VCSStatus (G06-Status Notification of VCS) use case for a charging completion status reporting, reporting a current status of the vehicular Charging Station (VCS) through a fourth VCS status report request message to the charging station management system (CSMS) after terminating a charging process, and receiving a fourth VCS status report response message.

17. The method of claim 15, wherein the first VCS status report request message includes a timestamp field, electric vehicle charging facility ID field, connector ID field, status field set to available, vehicular Charging Station (VCS) current location GPS location field, current charging status field, minimum charging status field, maximum available energy field, maximum traveling energy field, rate table field, charging specification field, connector type field, and support charging protocol field.

18. The method of claim 15, wherein the second VCS status report request message includes a timestamp field, electric vehicle charging facility ID field, connector ID field, V2V charging reservation status field, reserved electric vehicle information and type field, vehicular Charging Station current location GPS location field, and charging status field, maximum available energy field, and maximum traveling energy field.

19. The method of claim 15, wherein the third VCS status report request message includes a timestamp field, electric vehicle charging facility ID field, connector ID field, V2V charging usage status field, reserved electric vehicle information and type field, vehicular Charging Station current location GPS location field, and current charging status field, maximum available energy field, and maximum traveling energy field.

20. The method of claim 16,
wherein the fourth VCS status report request message includes a timestamp field, EV charging facility ID field, connector ID field, status field set to available, vehicular Charging Station (VCS) current location GPS location field, current charging status field, maximum available energy field, and maximum traveling energy field.
